(19) United States
(12) Patent Application Publication
(10) Pub. No.: US 2005/0008554 A1
(43) Pub. Date: Jan. 13, 2005

(54) Apparatus and process therewith

(76) Inventors: Marek Stefan Nowosielski-Slepowron, Boston, MA (US); Brian David Krafton, Wakefield, RI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/794,557

(22) Filed: Mar. 5, 2004

Related U.S. Application Data
(60) Provisional application No. 60/486,456, filed on Jul. 11, 2003.

(51) Int. Cl. C01G 43/025

(52) U.S. Cl. 423/16

(57) ABSTRACT

An apparatus that can be used for producing chlorine dioxide is provided. The apparatus comprises a single fluid proportioning device, which comprises three or more fluid transferring devices, a conduit to the inlet of each fluid transferring device, a conduit to the outlet of each fluid transferring device, a water inlet to the device, and a water outlet from the device in which the fluid transferring device is proportionally actuated by the flow of water through the device. Also provided is a process that can be used to produce chlorine dioxide. The process comprises flowing water through the fluid proportioning device to create a downstream water and to actuate the fluid transferring devices; drawing three or more precursor compounds each from a separate source and flowing each compound separately through one of the fluid transferring devices; and injecting the precursor compounds into the downstream water.

This application claims the benefits of provisional application 60/486,456, the entire disclosure of which is incorporated herein by reference.

### FIELD OF THE INVENTION

This invention relates to an apparatus and a process that can be used for producing an oxyhalo compound such as, for example, chlorine dioxide.

### BACKGROUND OF THE INVENTION

An oxyhalo compound is an important industrial chemical. For example, chlorine dioxide is a commercially important chemical for use as a bleaching, disinfection, oxidizing, fumigating, sanitizing or sterilizing agent and can replace chlorine and hypochlorite products traditionally used in such applications because it produces lower levels of chlorinated organic compounds than chlorine when it is used to treat raw water containing organic compounds. Chlorine dioxide is less corrosive than chlorine to metals. Production of chlorine dioxide is well known in the art. For example, U.S. Pat. No. 6,274,009 discloses a number of processes for its production. However, most processes disclosed present some disadvantages. Also, because of the potential safety hazards associated, the generation and use of chlorine dioxide solutions can be complex and requires sophisticated equipment thereby incurring unnecessary manufacturing cost. Development of a new apparatus and process for safely and efficiently producing chlorine dioxide can be a great contribution to the art.

### SUMMARY OF THE INVENTION

An apparatus that can be used to produce an oxyhalo compound is provided which comprises a fluid proportioning device comprising three or more fluid transferring devices, a conduit to the inlet of each fluid transferring device, a conduit to the outlet of each cylinder, a water inlet to the device, and a water outlet from the device.

A process that can be used for producing a chemical is provided. The process comprises introducing a water flow to and through an apparatus to produce a downstream water; feeding three or more precursor chemicals at a proportional rate to each other to and through the apparatus by using the water flow as a motive force for proportionally feeding the precursor chemicals at a rate relative to the water flow; and combining the precursor chemicals with the downstream water whereby a chemical reaction occurs between two or more of the precursor chemicals. The apparatus can be the same as that disclosed above.

### BRIEF DESCRIPTION OF THE DRAWINGS

FIG. 1 shows a flow diagram of an apparatus.

FIG. 2 shows the front and side of an apparatus.

### DETAILED DESCRIPTION OF THE INVENTION

An apparatus that is capable of transporting three or more precursor chemicals or compounds to a reaction medium such as, for example, water for producing a product by reaction of two or more of these precursor chemicals is disclosed. The apparatus can comprise a fluid proportioning device, which comprises a water inlet; a water outlet; a main water-driven drive assembly; and a first, a second, a third, and optionally additionally fluid transferring devices. The water inlet is connectable to a water source and the fluid transferring device can comprise a transferring device inlet and a transferring device outlet, each being connectable to a conduit. The water source is capable of producing a water flow into and through the main water-driven drive assembly thereby producing a downstream water through said water outlet. Each of the fluid transferring devices is proportionally actuated by the water flow thereby withdrawing through the first, second, third, and optionally additional fluid transferring devices through which precursor chemicals are respectively drawn in a proportional amount independent of the flow rate of the water flow and discharging, for example, the precursor chemicals to said downstream water.

The fluid proportioning device can comprise an inlet end connectable to a water source with an inlet conduit. The proportioning device also comprises an outlet end connectable to an outlet conduit. Water can flow to the inlet and through the proportioning device exiting the outlet thereby creating a downstream water. The outlet end is connectable to the downstream water with the outlet conduit.

The main water-driven drive assembly is directly coupled to each of the respective fluid-fluid transferring devices, thus providing proportioned chemical feeds relative to the drive water flow.

The first, second, third, and optionally additional chemical inlet ports through which precursor chemicals can be respectively drawn into and through the fluid transferring devices by individual conduits. Through the fluid transferring devices, the proportioning device comprises a first, a second, a third, and optionally additional chemical outlet ports through which the precursor chemicals are respectively drawn to the downstream water by and through these individual conduits. The individual conduits can enter the downstream water at one or more locations, preferably at two or more locations or points.

Each fluid transferring device also comprises a metering piston.

The proportioning device can also comprise a piston actuator for reciprocally moving each metering piston within its respective fluid transferring device. The actuator can have an actuating fluid inlet and an actuating fluid outlet. The actuating fluid inlet can be connected to the conduit downstream of the inlet end. The actuating fluid outlet can be connected to the conduit upstream of the precursor chemical inlet ports therein. The actuator is generally responsive to a flow of water through the conduit to reciprocate each metering piston within its associated fluid transferring device thereby drawing a respective metered amount of precursor chemical from its source and to inject or introduce that metered amount of precursor chemical, which can be fixed or adjusted at the actuator, into the conduit through a chemical inlet port therein.

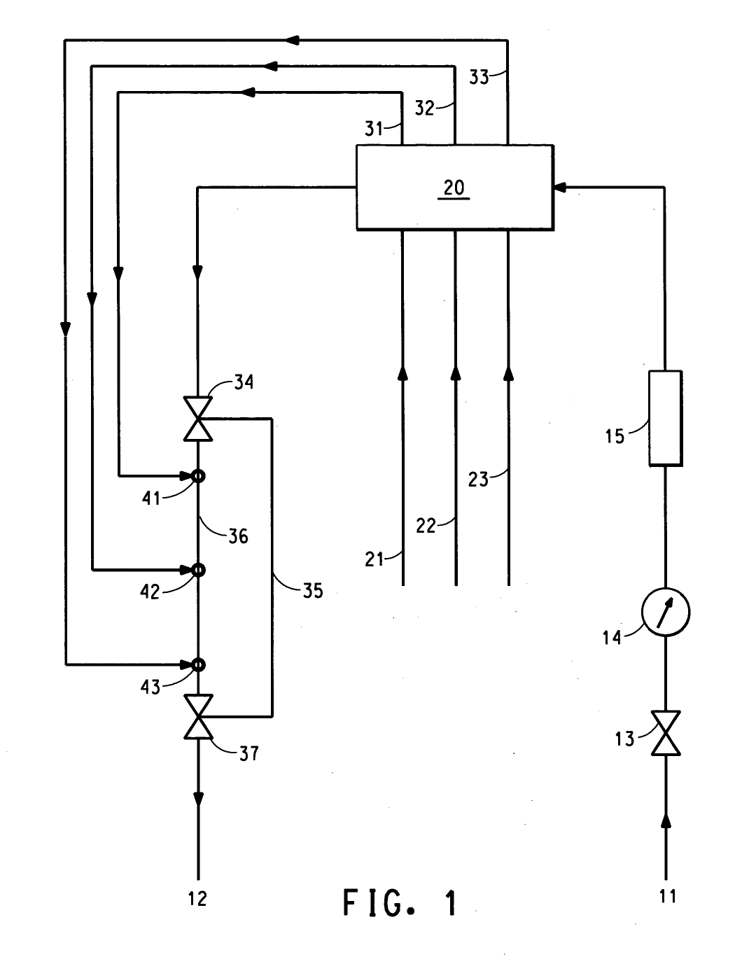

Referring to FIG. 1, a flow diagram of the apparatus is shown. The apparatus is illustrated herein with three fluid transferring devices, though more than three can be used for a variety of applications. Water flows through inlet 11, though valve 13 which controls the amount of water flow, preferred valve is a pressure regulating valve, pressure gauge 14, a flowmeter 15 measuring the quantity of water flow therethrough, and through a proportioning device 20, through which the water stream flows to outlet 12. Precursor chemicals such as, for example, a metal hypochlorite, a metal chlorite, and a mineral acid, as disclosed below, can be independently fed to and through lines or conduits 21, 22, and 23 to the fluid transferring devices of the proportioning device 20. The chemicals carried by conduits 21, 22, and 23 independently exit the fluid transferring devices of device 20 through conduits or conduits 31, 32, and 33. Conduits 31, 32, and 33 independently enter conduit 36. These conduits can be made from any suitable materials such as, for example, plastics and corrosion-resistant metals. Through control valves such as, for example, check valves, 41, 42, and 43, the precursor chemicals that are useful for producing another chemical such as, for example, an oxyhalo compound that is more fully disclosed below, carried by conduits 21, 22, and 23 reenter conduit 36 and can be diluted by the downstream water in conduit 36. Reaction takes place at where two or more precursor chemicals meet and an oxyhalo compound can be produced forming an aqueous solution. Alternatively, the three or more precursor chemicals can be pre-reacted in a chamber or a conduit prior to injection or introduction into the downstream water conduit 36. Other means such as, for example, a solenoid, a modulating flow control valve or a pressure-regulating valve can be used in place of valve 13 to control the amount of water.

Proportioning device 20 can be any suitable device disclosed above and can be a pump. A preferred pump is a proportioning pump such as that disclosed in U.S. Pat. No. 4,572,229 or U.S. Pat. No. 5,433,240 with the exception that three or more slave cylinders disclosed in the patents are used herein as fluid transferring devices. Each fluid transferring device can be the same as that disclosed in U.S. Pat. No. 4,572,229 or U.S. Pat. No. 5,433,240 with the exception that additional cylinders having connecting rods are included in the proportioning device used herein. The entire disclosures of these patents are incorporated herein by reference. Other devices that can be used include those disclosed in U.S. Pat. Nos. 3,131,707; 3,114,379; 3,213,873; 3,213,796; and 3,291,066.

The drive water flowing through the apparatus can be variable within the hydraulic limitations of the device and in doing so can self proportion the chemicals transferred through each of the fluid transferring devices, thereby delivering consistent concentrations of individual precursor chemicals to be reacted to produce a desired chemical, at a consistent concentration, such as an oxyhalo compound over the drive water flow range. That is, the concentration ratio of precursor chemicals can remain constant.

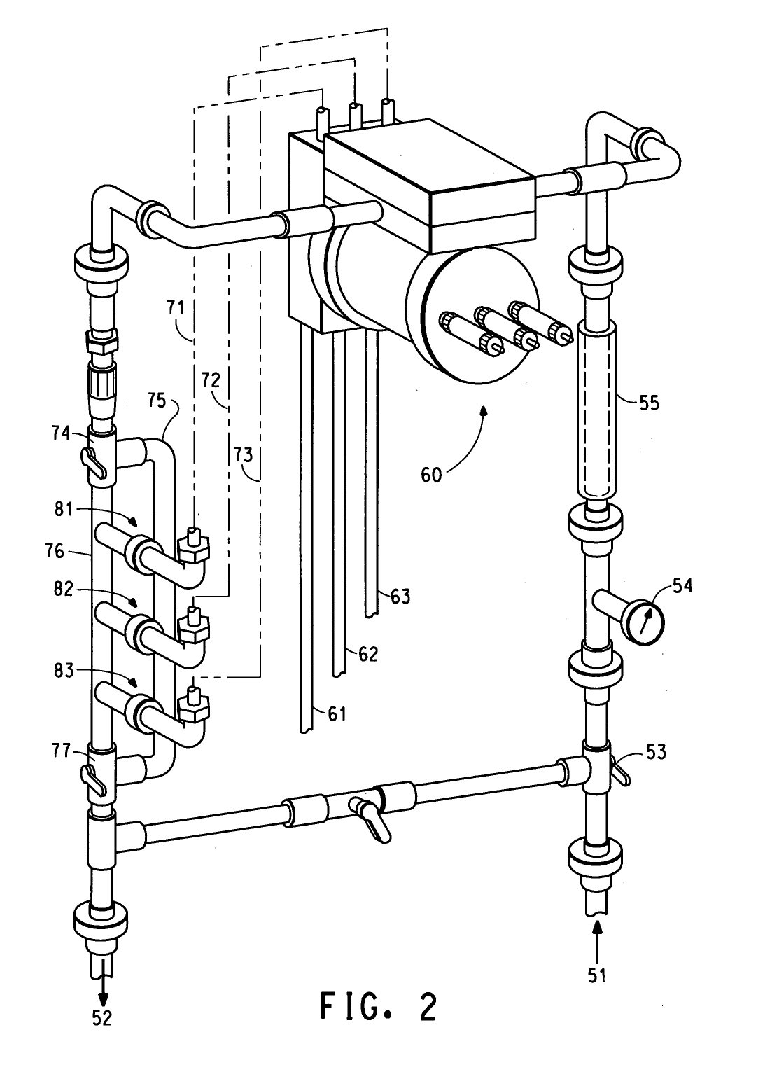

FIG. 2 illustrates an embodiment of the apparatus where inlet water (drive water) flows passing a local pressure gauge 54 and flow indicator 55. The water, under pressure, enters the proportioning pump 60. A proportioning device illustrated herein is a proportioning pump such as shown in reference numeral 60, which is commercially available from Crown Technology Corporation, Boise, Id. The term “proportioning” pump refers to a pump that proportionally mixes fluids by automatic, self-powered devices. The water can be considered “drive” water as it is used to drive the main internal piston assembly, as disclosed in U.S. Pat. No. 4,572,229 and U.S. Pat. No. 5,433,240, which is used to actuate the three individual pistons within the pump (fluid transferring devices or pump cylinders). As the fluid transferring device or cylinder pistons actuate back and forth, the individual precursor compounds are drawn in from conduits 61, 62, and 63 and then displaced out of the pump cylinder chambers each complete piston cycle. The volume of each pump cylinder chamber can be fixed but is adjustable using an external chemical feed adjustment dial (reference numerals 64, 65, and 66). As water flow varies through the pump drive assembly, the frequency of piston actuation remains proportional to the water flow. This remains proportional, each of the precursor chemicals feeds proportionally to the varying flow thus providing constant chemical concentration in the water outlet. The safety benefit in the mode of operation is that if water flow to the pump stops, so does the injection or introduction of precursor chemicals.

As the drive water exits the pump, it passes an in-line check valve (reference numerals 81, 82, and 83). Following this check valve are three individual chemical injection points. Optionally these three precursor chemicals can be injected or introduced simultaneously at one injection point. As each pump cycle is completed, the proportioned chemicals leaving the fluid transferring devices can be injected or introduced into each of these points (under pressure provided by the displacement portion of the piston cycle) or at the same point. Once injected or introduced, these precursor chemicals can be immediately diluted by the drive water that has passed through the proportioning device or pump. Once two or more precursor chemicals have been injected or introduced, they combine in-stream and react to form the desire product such as, for example, dilute solution of chlorine dioxide (ClO₂) as disclosed below.

Alternatively, a portion of water can be diverted to by-pass conduit 35 or 75. Valve 34 or 74 can be used to control the amount water going through conduit 36 or 76 that is used to dilute precursor compounds exiting from proportioning device 20 or 60 via conduits 31, 32, and 33 (71, 72, and 73 in FIG. 2) entering the water stream at 41, 42, and 43 (81, 82, and 83 in FIG. 2). Water diverted through conduit 35 or 75 reenters conduit 36 or 76 downstream. There are ways to react more concentrated precursor chemicals. For example, rather than simply injecting or introducing the precursor chemicals into the drive water stream (down-stream of the pump), the precursor chemicals can be pre-reacted in a small chamber just prior to further dilution in the drive water.

Also disclosed in the invention is a process that can be used for producing an oxyhalo compound. An oxyhalo compound, as used herein, refers to a chemical compound containing at least one halogen and one oxygen in the molecule. Examples of suitable oxyhalo compounds include, but are not limited to, chlorine dioxide, bromine dioxide, hypochlorous acid, hypobromous acid, hypochlorites, hypobromites, chlorous acid, acidified sodium chlorite, and combinations of two or more thereof.

The process can comprise introducing a water flow to and through an apparatus disclosed above to produce a downstream water; feeding three or more precursor chemicals at a proportional rate to each other to and through the apparatus; and combining the precursor chemicals with the downstream water wherein the water flow is used as a motive force for proportionally feeding the precursor chemicals to and through the apparatus at a rate relative to the water flow whereby a chemical reaction occurs between two or more of the precursor chemicals.

The process can also comprise (a) flowing water through a fluid proportioning device, which can be as the one disclosed above to create a downstream water and to actuate the fluid transferring devices; (b) drawing three or more precursor compounds each from a separate source and flowing each of the precursor compounds separately through one of the fluid transferring devices; and (c) injecting or introducing the precursor compounds into the downstream water whereby a chemical reaction occurs between two or more of the precursor chemicals.

Any precursor chemicals known to one skilled in the art can be used. For example, suitable precursor compounds for producing chlorine dioxide are well known in the art. Illustrated examples include a metal chlorite that can be contacted with an acid to produce chlorine dioxide. Also for example, chlorine dioxide can be produced by contacting (1) a metal chlorite and (2) a metal hypochlorite with (3) an acid. A metal chlorite can be an alkali metal chlorite, alkaline metal chlorite, or combinations thereof. Example of metal chlorite includes sodium chlorite, potassium chlorite, or combinations thereof. Similarly, a metal hypochlorite can be an alkali metal hypochlorite, alkaline metal hypochlorite, or combinations thereof. Example of metal hypochlorite includes sodium hypochlorite, potassium hypochlorite, or combinations thereof. Any mineral acid can be used. Example of such acid includes sulfuric acid, phosphoric acid, nitric acid, hydrochloric acid, or combinations thereof. The molar ratio of metal chlorite to acid can be in the range of from about 0.001:1 to about 100:1 or about 0.001:1 to about 10:1 and that of metal hypochlorite to acid can also be in the range of from about 0.001:1 to about 100:1 or about 0.001:1 to about 10:1.

Suitable precursor compounds can also include a metal chlorate, an oxidizing agent, and an acid. For example, chlorine dioxide can be produced by contacting (1) a metal chlorate and (2) an oxidizing agent with (3) an acid. A metal chlorate can be an alkali metal chlorate, alkaline metal chlorate, or combinations thereof. Example of metal chlorate includes sodium chlorate, potassium chlorate, or combinations thereof. Any oxidizing agent such as inorganic oxidizing agent, organic oxidizing agent, or combinations thereof can be used. Example of oxidizing agent includes hydrogen peroxide, peracetic acid, oxides of nitrogen, sodium peroxide, benzoyl peroxide, m-chlorobenzoic acid, m-bromobenzoic acid, p-chlorobenzoic acid, or combinations thereof. Any acid disclosed above can be used. The molar ratio of metal chlorate to acid can be in the range of from about 0.001:1 to about 10:1 and that of oxidizing agent to acid can also be in the range of from about 0.001:1 to about 10:1.

Other precursor compounds for producing oxyhalo compounds include, but are not limited to; Sodium bromide and sodium hypochlorite, chlorine, organic acids and mineral acids.

The precursor compounds can be combined, for example, by mixing with a mechanical mixer or static mixer. The production can be carried out under any suitable conditions. It is preferred that an apparatus disclosed above be used for.

A chemical product such as chlorine dioxide in water can be transferred to a holding tank or to its ultimate end use, for example, a municipal water treatment plant or the treatment of waste in a sewage plant. A colorimeter can be used to monitor the chlorine dioxide concentration, if desired. The solution can also be monitored by pH meter and the pH can be accordingly adjusted to about 2.0-10 by any means known to one skilled in the art. Alternative means of monitoring include ORP (oxidation reduction potential), residual monitors, and spectrophotometric analyzers.

The process is preferably carried out at a turndown rate of at least about 40:1, preferably at least about 20:1, and more preferably at least 10:1. The term “turndown” is defined as the ratio of the maximum to the minimum oxyhalo compound, such as chlorine dioxide, production rate achievable by the equipment.

Also disclosed is a process for producing a ClO₂-containing water. The process comprises flowing water to produce a downstream water; and feeding into the downstream water three or more precursor chemicals at a rate relative to the flow of the water and at proportional rates to each other thereby producing the ClO₂-containing water in which the flowing water provides a motive force for proportionally feeding the precursor chemicals to the downstream water.

The dilute solution of ClO₂ can be then directed to a point of application. Illustrative applications can include, but are not limited to, food contact sanitation, dairy sweet water systems, dairy process water disinfection (cooling water, heating water, potable), dairy pasteurizers, dairy CIP (cleaning-in-place) systems, dairy hard surface, sanitation/disinfection, dairy fermentor process aid, poultry plant process water disinfection (dip chillers and flash cool air chillers, scalders), poultry plant CIP sanitation/disinfection, poultry plant hard surface sanitation/disinfection, meat plant process water disinfection (cooling water, heating water, dip chillers, flash cool air chillers, brine shower chillers), meat processing carcass rinse, meat plant CIP sanitation/disinfection, meat plant hard surface sanitation/disinfection, fruit and vegetable processing plant process water disinfection (cooling water, heating water, hydro-cooler treatment, vegetable rinses, flume water), fruit and vegetable processor CIP systems, fruit and vegetable processing plant hard surface sanitation/disinfection, fruit and vegetable storage treatment (pre-storage treatment, humidification systems treatment), mushroom processing sanitation/disinfection, brewery/beverage plant process water disinfection (cooling water, heating water, potable water), brewery/beverage plant CIP systems, brewery/beverage plant hard surface sanitation/disinfection, pet-bone treatment/disinfection, animal drinking water disinfection, fogging and spraying swine, poultry, cattle, kennels, grow-out bins, aquaculture treatment, bio-film removal, waste water treatment, emulsions, chemical destruction (including but not limited to phenolics, nitrogen oxides (noₓ), sulfur oxides (SOₓ) and cyanides), oil well treatment, water storage systems, adhesives, paper manufacturing and recycling (white water disinfection, slime control, pulp bleaching and de-fluorescence), cooling towers , process water disinfection (incoming raw water, cooling water, heating water, grey water), air scrubbers, heating and ventilation systems, odor control, molluscicide, water filtration system treatment (bio-film removal/disinfection), hospitals, medical clinics, dental offices, nursing homes, laboratories, morgues, salons, domestic water treatment, recreational water disinfection (potable, stored), maritime water treatment (stored potable, black water, gray water, storage tank disinfection, bio-film removal), maritime hard surface sanitation, aviation water treatment (stored potable, tank disinfection, bio-film removal)), commercial water filtration system treatment (bio-film removal/disinfection), or combinations thereof.

### EXAMPLES

The following examples are provided to illustrate the invention and are not to be construed as to unduly limit the scope of the invention.

Potable water was fed to an apparatus through a filter to remove particulate. A water booster pump was used to generate test pressures above available potable water line pressure. The apparatus including a triple headed hydraulic metering pump as shown in FIG. 2, with the exception that injection points 81 and 82 were relatively close and that a static mixer was placed between reference numerals 82 and 83, was used to convey and inject precursor chemicals (precursor chemicals described below). The ratio of the flow rates of the precursor chemicals to each other and to the motive water flow were manipulated by adjusting the stroke length on each the three chemical dosing cylinders on the pump.

Samples were withdrawn through the sample valve as described below and analyzed as described below. For some tests the configuration of the apparatus was varied as detailed below.

Precursor Chemicals Chlorine Dioxide was generated from the following precursor chemicals: (1) sodium chlorite solution (25% (w/w); obtained from IDI, North Kingstown, R.I., USA); (2) sodium hypochlorite solution (10.5% (w/w); purchased from RJ Pool, Cranston, R.I.; USA; assayed by iodometric titration at 12.4% (w/w) sodium hypochlorite); and (3) hydrochloric acid solution (31.45% (w/w); purchased from Mancini Hardware, North Kingstown, R.I.: USA).

Sampling and Analysis

Samples (250 ml each were drawn through the sample valve into brown Nalgene® sample bottles. Sampling and analysis was carried out as described in Standard Methods for the Examination of Water and Wastewater, 20^{th} ed., 1998. Method 4500-ClO₂ E, prepared and published jointly by; American Public Health Association, American Water Works Association, Water Environmental Association. Publication Office, Washington D.C. Sample chlorine dioxide concentration was determined using a Hach® (Loveland, Colo., USA) DR/2000 Direct Reading Spectrophotometer. The sample was diluted with 4 parts of de-ionized water, unless otherwise noted. This test was carried out to Hach's® DR/2000 Method 75 at a wavelength of 445 nm.

Sample pH was determined using an Orion® (Beverly, Mass., USA) combination pH probe and pH meter.

Chlorine dioxide was removed from samples by degassing with sparged air for a minimum period of 15 minutes.

De-gassed sample chlorite ion and chlorate ion was determined by use of a Dionex® (Sunnyvale, Calif,.) DX-120 Ion Chromatograph. A Dionex® AS40 Automated Sampler was used. All samples were analyzed in duplicate. A Dionex® AS9SC Column and ASRS suppressor was utilized with a 7 to 8 mM bicarbonate eluent with a 2 ml/minute flow. This method was consistent with EPA Method 300.

Calculations

Efficiency % was calculated as:

$$Generator\_Efficiency ( \% ) = \frac{[ Cl {O}_{2} ]}{[ Cl {O}_{2} ] + [ Cl {O}_{2}^{-} ]} \times 100$$

where [ClO₂]=Chlorine Dioxide Concentration, mg/l and [ClO₂⁻]=chlorite ion concentration, mg/l. [ClO₂] and [ClO₂⁻] were determined by method AM-100-07 revA or [ClO₂] was determined by the DR/2000 spectrophotometer method 75 and [ClO₂⁻] was determined by ion chromatography.

Yield, as defined in EPA Guidance Manual: Alternative Disinfectants and Oxidants, EPA, April 1999, pp. 4-3, yield was calculated as:

$$Yield ( \% ) = \frac{[ Cl {O}_{2} ]}{[ Cl {O}_{2} ] + [ Cl {O}_{2}^{-} ] + ( \frac{67.45}{83.45} ) [ Cl {O}_{3}^{-} ]} \times 100$$

where [ClO₃⁻]=chlorate ion concentration, mg/l and (67.45/83.45)=molecular weight ratio of ClO₂³¹ to ClO₃⁻

Purity, as defined in EPA Guidance Manual: Alternative Disinfectants and Oxidants, EPA, April 1999, pp. 4-4, was calculated as:

$$Purity ( \% ) = \frac{[ Cl {O}_{2} ]}{[ Cl {O}_{2} ] + [ FAC ] + [ Cl {O}_{2}^{-} ] + [ Cl {O}_{3}^{-} ]} \times 100$$

where [FAC]=free available chlorine concentration as chlorine, mg/l.

### Example 1

This example illustrates that the invention provides high efficiency, yield and purity with low excess chlorine.

Eight samples were obtained with the sodium chlorite being fed at 85% of the maximum rate, sodium hypochlorite being fed at 100% of the maximum rate and hydrochloric acid being fed at 40% of the maximum rate. The motive water inlet pressure was adjusted to vary the chlorine dioxide solution flow. Two samples were taken at 1.5 US gallons per minute (GPM), four at 3.0 GPM and two at 6.0 GPM. This represented a chlorine dioxide production rate of 35 to 142 PPD (pounds per day) ClO₂.

Excess chlorine as defined in EPA Guidance Manual: Alternative Disinfectants and Oxidants, EPA, April 1999, pp. 4-3, was measured at less than 0.1%. This represents an extremely low excess chlorine concentration.

Chlorine dioxide concentration was measured from 1940 to 2010 mg/l with a mean of 1974 mg/l. Chlorite ion concentration was measured from 1.0 mg/l to 6.1 mg/l, with a mean of 3.3 mg/l. Chlorate ion concentration was measured from 118 mg/l to 145 mg/l, with a mean of 132 mg/l.

The efficiency as measured by spectrophotometry and ion chromatography varied from 99.7% to 99.9% with a mean of 99.8%.

The yield as measured by spectrophotometry and ion chromatography varied from 94.2% to 95.3% with a mean of 94.7%.

The purity as measured by spectrophotometry and ion chromatography varied from 93.0% to 94.3% with a mean of 93.6%.

### Example 2

This example shows the effect of reduced chlorine dioxide solution flow rate.

The apparatus was run as in Example 1, but with reduced chlorine dioxide solution flow rates of 0.75 GPM and 0.30 GPM to demonstrate further turndown. For 0.75 GPM yield's of 93.9% and 93.8% was obtained. For 0.3 GPM 89.4% and 87.8% was obtained.

### Example 3

This example demonstrates that chlorate ion in the chlorine dioxide solution is present partially due to its presence as an impurity in the precursor sodium hypochlorite solution.

The apparatus was run as Example 1, but potable water was used in place of the sodium chlorite and hydrochloric acid feeds. A mean of 76 mg/l of chlorate ion was measured in the samples. This indicated that some of the chlorate measured in Example 1 formed as a byproduct of the chlorine dioxide generation, but is an impurity in the sodium hypochlorite feed. Recalculating the yield by compensating for this background chlorate resulted in yields from 97.1% to 98.3% with a mean of 98.7% for Example 1.

### Example 4

This example demonstrates the effect of changing hydrochloric acid feed rate.

The apparatus was run with the sodium chlorite being fed at 88% of the maximum rate, Sodium hypochlorite being fed at 100% of the maximum rate and hydrochloric acid being fed at between 30% and 50% of the maximum rate. The chlorine dioxide solution flow was kept at 3.0 GPM.

| | Chlorine Dioxide | |
|---|---|---|
| Acid Feed (%) | Solution pH | Yield (%) |
| 50 | 2.07 | 94.6 |
| 50 | 2.15 | 94.6 |
| 45 | 2.32 | 94.7 |
| 45 | 2.35 | 94.7 |
| 40 | 2.58 | 93.5 |
| 40 | 2.62 | 93.9 |
| 35 | 4.66 | 89.6 |
| 35 | 4.68 | 89.1 |
| 30 | 6.12 | 81.0 |
| 30 | 6.2 | 80.6 |

### Example 5

This example demonstrates that separating hypochlorite/acid and chlorite injection points improves yield For two samples, the apparatus was as shown in FIG. 2 with the exception that the injections points 81, 82 and 83 were relatively close than FIG. 2 shows and there was a static mixers downstream of 83; the chlorite was injected immediately down stream of the hypochlorite and acid injection point. The yields obtained was 91.2% and 91.3%, about 3.5% lower than the mean yield for Example 1, where there was residence time between the hypochlorite/acid and chlorite injection points.

### Example 6

This example shows that using a static mixer improve yield.

For four samples, the apparatus was the same as that disclosed for Examples 1-4 except that the static mixers were replaced with a schedule 80 pipe, which is well known to one skilled in the art. The yields obtained were from 93.7% about 94.0%, with a mean of 93.8%. This mean was 0.9% lower than the mean yield for Example 1, demonstrating that the static mixers improve yield.

### Example 7

This example illustrates using a static mixer between hypochlorite/acid and chlorite injection points.

For six samples, the apparatus was the same as that used Example 6. The yields obtained were from 93.0% to 95.9%, with a mean of 94.1 %. This mean is 0.6% lower than the mean yield for Example 1, demonstrating that the static mixers between the injection points improved the yield. The yields were also higher than for Example 6, demonstrating that the static mixer after the chlorite injection point improved yield.

### Example 8

This example shows the effect of ClO₂ concentration turndown.

For these samples, the apparatus was the same as that used in Example 6. The ratio of the precursors to each other was kept constant, but the ratio to the motive water flow was reduced.

| Chlorine Dioxide | |
|---|---|
| Concentration (mg/l) | Yield (%) |
| 2165 | 94.2 |
| 2145 | 93.6 |
| 1125 | 94.6 |
| 1140 | 96.7 |
| 505 | 93.1 |
| 490 | 98.1 |
| 130 | 92.1 |
| 130 | 89.9 |

Combining the turndown ratios demonstrated in Example 1 by adjusting the chlorine dioxide solution flow and this example demonstrating turndown in chlorine dioxide production rate of at least 40:1.

1. An apparatus comprising a fluid proportioning device which comprises a water inlet; a water outlet; a main water-driven drive assembly; and a first, a second, a third, and optionally additionally fluid transferring devices wherein
said water inlet is connectable to a water source; said fluid transferring device comprises a transferring device inlet and a transferring device outlet, each being connectable to a conduit;
said water source is capable of producing a water flow into and through said main water-driven drive assembly thereby producing a downstream water through said water outlet; and
each of said fluid transferring devices is proportionally actuated by said water flow thereby withdrawing through said first, second, third, and optionally additional fluid transferring devices through which precursor chemicals are respectively drawn in a proportional amount dependent on the flow rate of said water flow and discharging said precursor chemicals to said downstream water with or without prior mixing of the precursors.

2. An apparatus according to claim 1 wherein said proportioning device comprises a piston actuator comprising an actuating fluid inlet and an actuating fluid outlet; each of said fluid transferring device comprises an inlet port, an outlet port, and a metering piston therein; and said actuator reciprocally moves said metering piston within said fluid transferring device.

3. An apparatus according to claim 1 wherein said apparatus comprises single proportioning device.

4. An apparatus according to claim 1 wherein said precursor chemicals are capable of undergoing a chemical reaction.

5. An apparatus according to claim 4 wherein said precursor chemicals are capable of undergoing a chemical reaction thereby producing a product.

6. An apparatus according to claim 5 wherein said product is an oxy-halogen species.

7. An apparatus according to claim 6 wherein said product is chlorine dioxide, acidified chlorite, chlorous acid or combinations thereof.

8. An apparatus comprising a single fluid proportioning device which comprises a water inlet; a water outlet; a main water-driven drive assembly; and a first, a second, a third, and optionally additionally fluid transferring devices wherein
said water inlet is connectable to a water source; said fluid transferring device comprises a transferring device inlet and a transferring device outlet, each being connectable to a conduit;
said water source is capable of producing a water flow into and through said main water-driven drive assembly thereby producing a downstream water through said water outlet; and
each of said fluid transferring device is proportionally actuated by said water flow thereby withdrawing through said first, second, third, and optionally additional fluid transferring devices through which precursor chemicals are respectively drawn in a proportional amount dependent on the flow rate of said water flow and discharging said precursor chemicals to said downstream water with or without prior mixing of the precursors, to generate chlorine dioxide.

9. An apparatus according to claim 8 wherein said proportioning device comprises a piston actuator comprising an actuating fluid inlet and an actuating fluid outlet; each of said fluid transferring device comprises an inlet port, an outlet port, and a metering piston therein; said actuator reciprocally moves said metering piston within said fluid transferring device; and through said transferring device precursor chemicals are respectively drawn in a proportional amount dependent on the flow rate of said water flow and discharging said precursor chemicals to said downstream water with or without prior mixing of the precursors.

10. An apparatus according to claim 9 wherein said precursor chemicals are capable of undergoing a chemical reaction thereby producing a product.

11. An apparatus according to claim 10 wherein said product is an oxy-halogen species.

12. An apparatus according to claim 9 wherein said product is chlorine dioxide, acidified chlorite, chlorous acid or combinations thereof.

13. A process comprising (a) flowing water through a fluid proportioning device, which comprises three or more fluid transferring devices, to create a downstream water and to actuate said fluid transferring devices; (b) drawing three or more precursor compounds each from a separate source and flowing each said compounds separately through one of said fluid transferring devices; and (c) injecting said precursor compounds into said downstream water whereby an oxyhalo compound solution is produced.

14. A process according to claim 13 wherein said fluid proportioning device comprises three or more fluid transferring devices, a conduit to the inlet of each fluid transferring device, a conduit to the outlet of each fluid transferring device, a water inlet connectable to a water source, and a water outlet from said device; and said fluid transferring device is proportionally actuated by the flow of water through said device to generate said oxyhalo compound.

15. A process according to claim 14 wherein said proportioning device comprises a main water-driven drive assembly into and through which water is drawn from said water source thereby producing a downstream water; an outlet end connectable to said downstream water; a first, a second, a third, and optionally additional chemical inlet ports through which precursor chemicals are respectively drawn into and through said fluid transferring devices; a first, a second, a third, and optionally additional chemical outlet ports through which precursor chemicals are respectively discharged to said downstream water, with or without prior mixing of the precursors, by and through individual conduits.

16. A process according to claim 15 wherein each of said fluid transferring device comprises an inlet port, an outlet port, and a metering piston therein; said proportioning device comprises a piston actuator comprising an actuating fluid inlet and an actuating fluid outlet; said actuator reciprocally moves said metering piston within said fluid transferring device; and said oxyhalo compound is chlorine dioxide, acidified chlorite, chlorous acid or combinations thereof.

17. A process according to claim 13 wherein
said proportioning device comprises three or more fluid transferring devices, a conduit to the inlet of each fluid transferring device, a conduit to the outlet of each fluid transferring device, a water inlet connectable to a water source, and a water outlet from said device;
said oxyhalo compound is chlorine dioxide, acidified chlorite, chlorous acid or combinations of two or more thereof;
said fluid transferring device is proportionally actuated by the flow of water through said device to generate a solution of chlorine dioxide, acidified chlorite, chlorous acid or combinations thereof;
said proportioning device comprises a main water-driven drive assembly into and through which water is drawn from said water source thereby producing a downstream water; an outlet end connectable to said downstream water; a first, a second, a third, and optionally additional chemical inlet ports through which precursor chemicals are respectively drawn into and through said fluid transferring devices; a first, a second, a third, and optionally additional chemical outlet ports through which said precursor chemicals are respectively discharged to said downstream water by and through individual conduits; and
said fluid transferring device comprises an inlet port, an outlet port, and a metering piston therein; said proportioning device comprises a piston actuator comprising an actuating fluid inlet and an actuating fluid outlet; and said actuator reciprocally moves said metering piston within said fluid transferring device.

18. A process according to claim 17 further comprising contacting said solution of chlorine dioxide with a food processing equipment.

19. A process according to claim 18 wherein said processing equipment comprises food contact, dairy processing, poultry plant processing; poultry meat processing, fruit and vegetable processing, brewery or beverage processing, or combinations thereof.

20. A process according to claim 17 further comprising contacting said solution of chlorine dioxide with (1) an oil well and equipment therefore, therewith, or thereof; (2) paper manufacturing equipment; (3) waters used for cooling tower; (4) waters being treated to form potable waters suitable for human consumption; (5) waste waters; (6) air scrubbing; (7) chemical destruction; or (8) combinations of two or more thereof.

21. A process comprising introducing a water flow to and through an apparatus that comprises three or more fluid transferring devices thereby producing a downstream water; feeding three or more precursor chemicals at a proportional rate to each other to and through said apparatus; and combining said precursor chemicals with said downstream water, with or without prior mixing of the precursors, wherein said water flow is used as a motive force for proportionally feeding said precursor chemicals to and through said apparatus at a rate relative to said water flow whereby a chemical reaction occurs between two or more of said precursor chemicals.

22. A process according to claim 21 wherein combining said precursor chemicals with said downstream water produces an oxyhalo-containing solution.

23. A process according to claim 22 wherein said water flow is adjusted automatically using a modulating control valve or variable pressure pump, to adjust the rate of oxyhalo-containing solution produced.

24. A process according to claim 22 wherein the rate of oxyhalo-containing solution produced is modulated by an external control signal.

25. A process according to claim 22 wherein said precursor chemical comprises either (1) metal bromide, metal hypochlorite or oxidizing agent, and acid; or (2) metal chlorite or metal chlorate, metal hypochlorite or oxidizing agent, and acid; or (3) alkali metal chlorite or alkaline metal chlorite or both; alkali metal hypochlorite or alkaline metal hypochlorite or both; and acid; or (4) combinations of any two or more of (1), (2), and (3).

26. A process according to claim 22 wherein said precursor chemical comprises (1) said alkali metal chlorate, alkaline metal chlorate, or combinations thereof; (2) inorganic oxidizing agent, organic oxidizing agent, or combinations thereof, and (3) acid.

27. A process according to claim 22 wherein said precursor chemical comprises (1) sodium chlorite, potassium chlorite, or both; (2) sodium hypochlorite, potassium hypochlorite, or both; and (3) sulfuric acid, phosphoric acid, nitric acid, hydrochloric acid, or other mineral or organic acids or combinations thereof.

28. A process according to claim 27 wherein said precursor chemical comprises (1) sodium chlorate, potassium chlorate, or combinations thereof; (2) hydrogen peroxide, peracetic acid, oxides of nitrogen, sodium peroxide, benzoyl peroxide, m-chlorobenzoic acid, m-bromobenzoic acid, p-chlorobenzoic acid, or combinations thereof; and (3) sulfuric acid, phosphoric acid, nitric acid, hydrochloric acid, or combinations thereof.

29. A process according to claim 28 wherein oxyhalo-containing solution is chlorine dioxide solution, acidified chlorite, chlorous acid or combinations thereof.

30. A process according to claim 29 further comprising contacting said chlorine dioxide solution with a food processing equipment.

31. A process according to claim 30 wherein said processing equipment comprises food contact, dairy processing, poultry plant processing poultry meat processing, fruit and vegetable processing, fruit and vegetable storage facilities, brewery or beverage processing, or combinations thereof.

32. A process according to claim 29 further comprising contacting said chlorine dioxide solution with (1) an oil well and equipment therefor, therewith, or thereof; (2) paper manufacturing equipment; (3) waters used for cooling purposes; (4) waters being treated to form potable waters suitable for human consumption; (5) waste waters; (6) air scrubbers: (7) chemical destruction; or (8) combinations thereof.

33. A process for producing a ClO₂-containing water comprising flowing water to produce a downstream water; and feeding into said downstream water three or more precursor chemicals at a rate relative to the flow of said water and at proportional rates to each other thereby producing said ClO₂-containing water wherein said flowing provides a motive force for proportionally feeding said precursor compounds to said downstream water.

34. A process according to claim 33 wherein said ClO₂ is produced in-situ in said downstream water.
